(19) United States
(12) Patent Application Publication
(10) Pub. No.: US 2005/0163076 A1
(43) Pub. Date: Jul. 28, 2005

(54) Method and apparatus for broadcasting on a shared packet data channel in a wireless communication network

(75) Inventors: Rath Vannithamby, San Diego, CA (US); Srinivasan Balasubramanian, San Diego, CA (US)

Correspondence Address: COATS & BENNETT, PLLC, P O BOX 5, RALEIGH, NC, 27602, US

(73) Assignee: Telefonaktiebolaget L M Ericsson (publ)

(21) Appl. No.: 11/032,723

(22) Filed: Jan. 11, 2005

Related U.S. Application Data
(60) Provisional application No. 60/536,159, filed on Jan. 13, 2004.

(51) Int. Cl. H04Q 7/00

(52) U.S. Cl. 370/329

(57) ABSTRACT

A wireless communication network uses a shared packet data channel to broadcast information intended for all or a subset of the mobile stations monitoring the shared channel, based on using an associated packet data control channel to identify which shared channel transmissions comprise broadcast information rather than mobile-specific packet data traffic. For example, in a 1xEV-DV wireless communication network, a base station system can be configured to send broadcast messages on a Forward Packet Data Channel (F-PDCH) based on identifying those broadcasts via an associated Forward Packet Data Control Channel (F-PDCCH). In one such embodiment, one or more Medium Access Control (MAC) IDs are designated as broadcast identifiers. Thus, the receipt of a broadcast MAC ID in one or more timeslots of the F-PDCCH by a mobile station indicates to that mobile station that the corresponding timeslot(s) on the F-PDCH carry broadcast information rather than mobile-specific packet data traffic.

### RELATED APPLICATIONS

This application claims priority under 35 U.S.C. § 119(e) from the U.S. provisional application filed on 13 Jan. 2004 and entitled “Sector Loading Broadcast Via F-PDCH.” That provisional application is identified by Ser. No. 60/536,159 and it is incorporated in its entirety herein by reference.

### BACKGROUND OF THE INVENTION

The present invention generally relates to wireless communication networks, and particularly relates to transmitting broadcast information over shared packet data channels.

Existing types of wireless communication networks generally provide one or more “channels” used to transmit information of common interest or applicability to multiple mobile stations. For example, certain types of physical layer or higher-layer signaling messages are sent via dedicated broadcast channels, or sent via one or more common control or overhead channels that are monitored by the mobile stations.

However, newer generations of wireless communication networks increasingly make use of “shared” packet data channels to send high-rate packet data traffic to respective ones of the mobile stations sharing such channels. Usually, these shared channels offer efficiency advantages over the use of per-mobile dedicated channels to carry packet data traffic, and offer higher data rates than typically are achieved using dedicated channels.

There may be certain types of information that are of particular interest to mobile stations operating on shared packet data channels, such as sector loading information. Further, mobile stations operating on shared channels may not monitor one or more of the channels that typically are used to broadcast information to dedicated-channel users.

### SUMMARY OF THE INVENTION

The present invention comprises a method and apparatus for sending broadcast information over a shared packet data channel that is otherwise used for sending packet data traffic individually targeted to respective ones of the mobile stations sharing the channel. While certain embodiments directly apply to the shared packet data channels defined by the IS-2000 standards and by the Wideband CDMA (W-CDMA) standards, the present invention broadly applies to wireless communication networks providing a shared packet data channel and an associated packet data control channel. More generally, the shared channel comprises any time or code-multiplexed, high-speed traffic channel used for individually serving multiple mobile stations, with the associated control channel carrying information identifying which transmissions on the shared channel are individually targeted to which ones of the mobile stations.

Thus, in one embodiment, a method of sending an in-traffic broadcast to all or a subset of mobile stations sharing a shared packet data channel comprises transmitting an in-traffic broadcast message on the shared packet data channel, and transmitting a corresponding broadcast identifier on an associated packet data control channel. The broadcast identifier indicates that the corresponding transmission on the shared packet data channel comprises an in-traffic broadcast message rather than packet data traffic individually targeted to a given one of the mobile stations. By way of non-limiting example, the shared packet data channel comprises a Forward Packet Data Channel (F-PDCH) being transmitted by a base station system in an IS-2000-based wireless communication network and the associated control channel comprises a corresponding Forward Packet Data Control Channel (F-PDCCH).

The broadcast information comprises, for example, Layer 3 signaling information, broadcast paging information, sector loading information, various In-Traffic System parameter messages, or broadcast/multicast data. Using the shared packet data channel to send broadcast information offers the advantage of having a high-bandwidth, “pipe” providing a flexible data payload for transmitting essentially any type of broadcast data. If desired, the information can be broadcast repetitively on the shared packet data channel, allowing the receiving mobile stations to improve reception reliability by, for example, chase-combining the repeated information.

In at least one embodiment, the control channel is synchronized with the shared data channel, and the transmission of a designated Medium Access Control (MAC) identifier in one or more timeslots of the control channel indicates that the corresponding timeslot(s) of the shared channel carry broadcast information intended for all or a subset of the mobile stations sharing the shared channel. The MAC identifier(s) used to indicate the transmission of broadcast information on the shared channel may be pre-configured by the network operator—e.g., stored statically as part of base station system provisioning—or may be set dynamically by the base station system during operation. If the MAC identifiers are selected dynamically, such selections are conveyed to the mobile stations, so that shared channel broadcasts are properly recognized. Note, too, that different MAC identifiers can be used to identify different types of broadcasts, and that different MAC identifiers can be used to broadcast to different subsets of the mobile stations.

Of course, the present invention is not limited to the above features and advantages. Those skilled in the art will recognize additional features and advantages of the present invention upon reading the following detailed description, and upon viewing the accompanying drawings.

### BRIEF DESCRIPTION OF THE DRAWINGS

FIG. 1 is a block diagram of one embodiment of a wireless communication network.

FIG. 2 is a logic flow diagram of processing logic supporting the transmission of broadcast information via a shared packet data channel.

FIG. 3 is a timing diagram of a multiplexed shared packet data channel, and its corresponding packet data control channel.

FIG. 4 is a logic flow diagram of processing logic supporting the transmission of given broadcast information over a shared packet data channel and over one or more “regular” broadcast or common control channels.

FIG. 5 is a block diagram of multiple radio sectors, as provided by the network of FIG. 1.

FIG. 6 is a signal diagram of a shared channel broadcast message that is used in one embodiment to transmit sector loading information on a shared packet data channel.

FIG. 7 is a signal diagram of a shared channel broadcast message that is used in another embodiment to transmit sector loading information on a shared packet data channel.

### DETAILED DESCRIPTION OF THE INVENTION

Selected types of wireless communication networks configure high-speed packet data channels for operation as time-multiplexed and/or code-multiplexed channels that are used to carry packet data for a plurality of different users. For example, the IS-2000 family of standards relating to 1×EV-DV wireless communication networks defines a Forward Packet Data Channel (F-PDCH) that is used to transmit high-rate packet data to different users at different times. That is, the F-PDCH is configured as a time-slotted channel, and multiple users can be served on the channel by scheduling the allocation of different slots to different users according to service goals, radio conditions, etc. The Wideband CDMA (W-CDMA) standards define a similar type of channel, referred to as the High Speed Downlink Packet Access (HSDPA) channel.

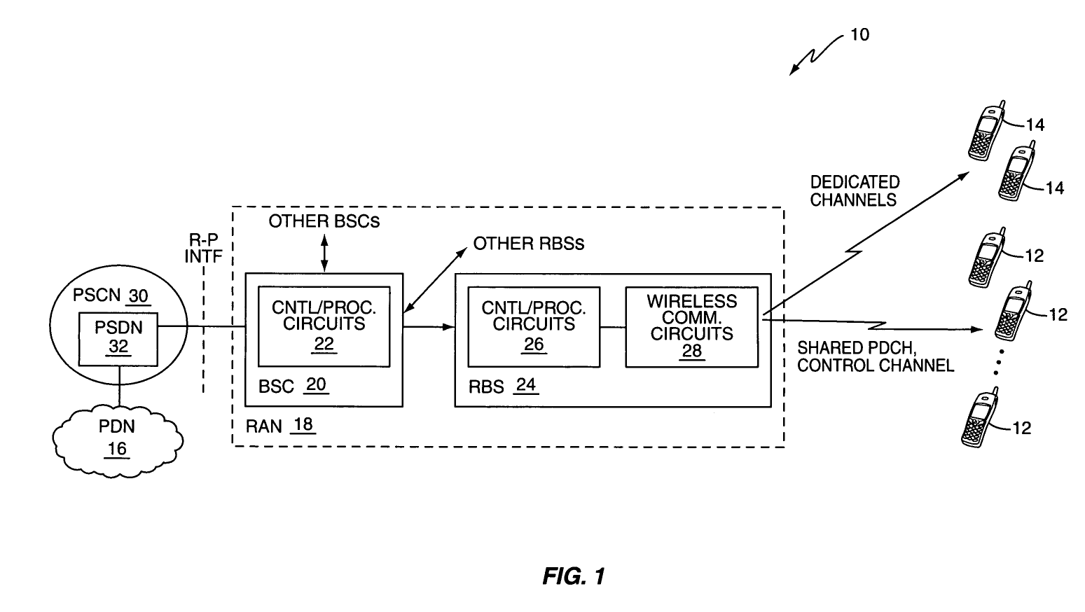

FIG. 1 illustrates one embodiment of a wireless communication network 10, which uses a shared packet data channel, such as those just described, for broadcast messaging, in addition to using the shared channel for delivering high-rate packet data traffic to individual users. With broadcast messaging, the broadcast information transmitted on the shared channel is intended for all or a subset of users (mobile stations) sharing the channel, in contrast to the individually targeted packet data traffic normally carried by the channel. As explained in more detail later herein, the network 10 uses a packet data control channel associated with the shared channel to manage broadcasting on the shared channel. By way of non-limiting example, the Forward Packet Data Control Channel (F-PDCCH) defined in 1×EV-DV standards can be used to manage broadcasting via an associated F-PDCH.

With the above context in mind, the illustrated embodiment of the network 10 communicatively couples mobile stations 12 and 14 to a Public Data Network (PDN) 16. For example, a shared packet data channel serves mobile stations 12, while a number of dedicated channels serve mobile stations 14. Note that dedicated channel service details are not germane to broadcasting on the shared packet data channel, and are mentioned only to illustrate the point that the network 10 may transmit a mix of shared and dedicated channels.

As illustrated, the network 10 comprises a Radio Access Network (RAN) 18 that includes a Base Station Controller (BSC) 20, with its control/processing circuits 22, and a Radio Base Station (RBS) 24, with its control/processing circuits 26 and its wireless communication circuits 28. The wireless communication circuits 28 may comprise radiofrequency transceiver circuits and associated signal processing circuits. The network 10 further includes a Packet Switched Core Network (PSCN) 30, including a Packet Data Serving Node (PDSN) 32 for transferring packet data to and from the RAN 18 through a Radio-Packet (RP) interface. The BSC 20 may include a Packet Control Function (PCF), or the like, to support the transfer of packet data to and from the PDSN 32.

Equivalently, a PCF may be separately implemented from the BSC 20. Such variations are contemplated herein, and it should be understood that the network 10 in actual implementation might include other entities not illustrated, or might have greater complexity, such as by including multiple RANs 18, BSCs 20, and/or RBSs 24. Note, too, that the network 10 can be configured to include a Circuit Switched Core Network (CSCN), supporting communications with the Public Switched Telephone Network (PSTN), for example.

In short, those skilled in the art should appreciate that the illustration of the network 10 is simplified to highlight one or more elements of the RAN 18 that are associated with transmitting broadcasting information on a shared packet data channel that otherwise provides packet data traffic that is individually targeted to respective ones of the mobile stations sharing the channel. More particularly, the RAN 18 comprises a base station system that transmits in-traffic broadcast messages on a shared packet data channel, and differentiates such transmissions from the individually targeted packet data otherwise being sent in multiplexed fashion on the shared channel by transmitting a corresponding broadcast identifier on an associated packet data control channel. In this context, the “base station system” at least comprises a RBS 24, and may further comprise an associated BSC 20, although the BSC 20 may or may not be involved in controlling broadcast transmissions on the shared channel.

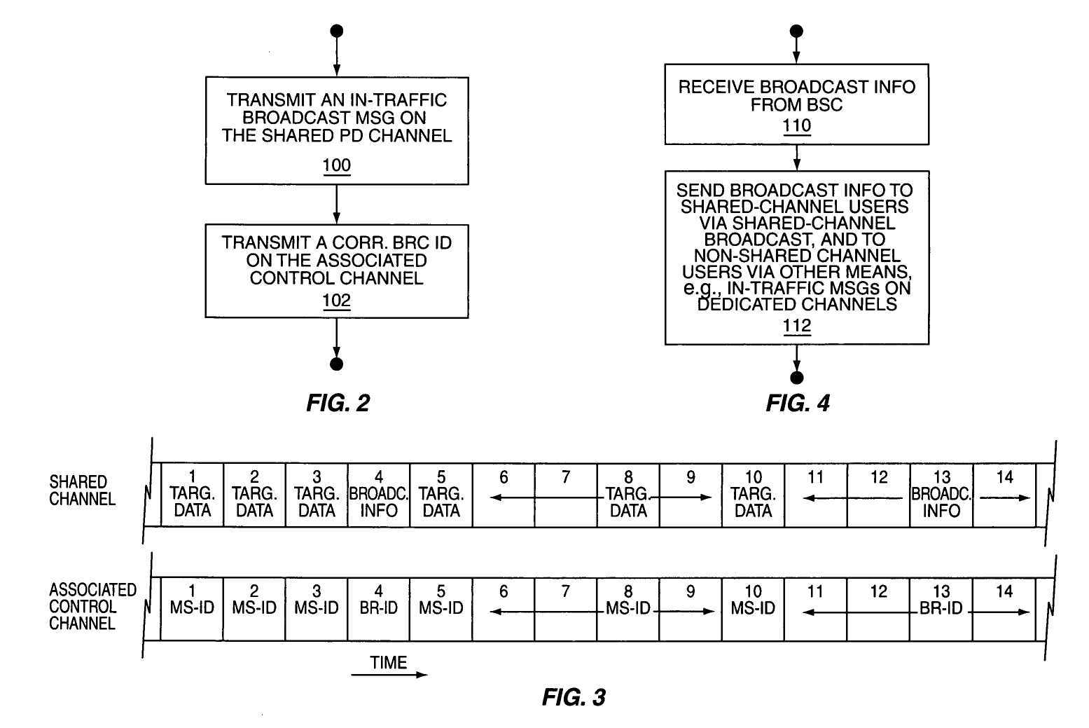

Regardless of whether broadcasting is controlled by the RBS 24, the BSC 20, or by some combination of the two, FIG. 2 broadly illustrates a general method of broadcasting on a shared packet data channel. The illustrated processing logic outlines a method of sending an in-traffic broadcast to all or a subset of the mobile stations 12 sharing the packet data channel being transmitted by the RBS 24. The method comprises transmitting an in-traffic broadcast message on the shared packet data channel (Step 100), and transmitting a corresponding broadcast identifier on the associated packet data control channel (Step 102). Sending a broadcast identifier on the associated control channel indicates to the mobile stations 12 that the corresponding transmission on the shared packet data channel comprises an in-traffic broadcast message rather than packet data traffic individually targeted to a given one of the mobile stations 12.

A better understanding of the shared (traffic) channel and control channel coordination may be gained from FIG. 3, which illustrates a time-multiplexed (slotted) shared packet data channel, and a correspondingly slotted packet data control channel. For 1×EV-DV systems, the shared channel comprises a F-PDCH being transmitted by the RBS 24 in one of the RBS's radio sectors, and the control channel comprises a F-PDCCH that is associated with the F-PDCH.

In this context, a “transmission” on the shared channel occupies one, two, or four 1.25 ms slots, and the corresponding control transmission on the control channel occupies the same number of slots. When one or more slots on the shared channel carry packet data traffic targeted to an individual one of the mobile stations 12 sharing the shared channel, the corresponding slot(s) on the control channel carry a Medium Access Control (MAC) identifier corresponding to the targeted mobile station 12.

Thus, when the shared channel is used to transmit individually targeted data, the control channel is used to identify the particular mobile station 12 targeted by the data. The transmission of mobile station identifiers in control channel slots is abbreviated “MS_ID” in the figure. Conversely, when the shared channel is used to transmit broadcast information, the control channel is used to indicate that status. From the illustration, one sees that the timeslots on the control channel corresponding to the transmission of broadcast information on the shared channel carry some type of “broadcast identifier,” which is abbreviated “BR_ID” in the figure. Typically, the timeslots of the control and shared channels are aligned, but the respective channel timings may be offset in some embodiments.

In at least one embodiment, different MAC IDs are used to identify different ones of the mobile stations 12 for the transmission of targeted packet data traffic on the shared channel, and one or more selected MAC IDs are used to identify the transmission of broadcast information on the shared channel. In one or more embodiments, the MAC ID or IDs used to connote broadcast transmissions on the shared channel are pre-configured. As such, a network operator or other entity can include the broadcast IDs in the provisioning information stored by the RBS 24 and/or the BSC 20, as both such entities include non-volatile memory and/or storage systems for retaining configuration data.

In another embodiment, the broadcast IDs are dynamically selected by the RBS 24 and/or by the BSC 20. Dynamic selection of the broadcast IDs requires communicating the currently selected broadcast identifier(s) to the mobile stations 12, so that broadcast transmissions are properly recognized, and any “on-the-fly” changes to the broadcast ID selections generally must be communicated to the mobile stations 12. Thus, dynamically updated broadcast ID information can be sent to the mobile stations 12 on an as-needed basis via messaging.

Regardless of whether statically or dynamically selected MAC IDs are used to identify broadcast transmissions on the shared channel, many different types of broadcast information can be sent via the shared channel. Broadly, at least three types of broadcast information advantageously can be sent on the shared channel: packet data payloads for broadcast/multicast services (i.e., BCMCS data), physical layer control information (e.g., radio sector loading/congestion information to support congestion control), and higher layer signaling information (e.g., Layer 3 signaling messages such as broadcast pages, neighbor lists, etc.). In one or more embodiments, different types of broadcast information are signified by transmitting different broadcast identifiers on the control channel—e.g., a different MAC ID can be transmitted on the control channel to indicate the different types of broadcast information being transmitted on the shared channel.

With this range in the types of broadcast information, those skilled in the art will recognize that some broadcasts on the shared channel can be triggered and/or managed by, the RBS 24, while other shared channel broadcasts can be triggered and/or managed by the BSC 20. Further, in one or more embodiments, the RBS 24 and/or the BSC 20 are configured to manage broadcasting where the information to be broadcasted is to be received by mobile stations 12 that are monitoring the shared channel and by mobile stations 14, which generally are not monitoring the shared channel—e.g., individual ones of the mobile stations 14 are allocated dedicated channels for the receipt of targeted traffic.

FIG. 4 illustrates such management, wherein the RBS 24 receives broadcast information from the BSC 20, or at least receives a broadcast trigger from the BSC 20. The RBS 24 determines that the broadcast information is intended for all or a subset of the mobile stations 12 and for all or a subset of the mobile stations 14. As such, the RBS 24 broadcasts the information to the mobile stations 12 via the shared channel as described earlier herein, and sends the information to the mobile stations 14 via some other means—e.g., as individually transmitted in-traffic messages on those users' dedicated channels.

In one alternative embodiment, the BSC 20 determines whether the broadcast information pertains to a mix of shared-channel and non-shared-channel mobile stations, and directs the various broadcasting operations of the RBS 24. In yet another embodiment, if the information to be broadcasted pertains to shared-channel and non-shared-channel mobile stations, the RBS 24 or the BSC 20, or some combination of the two, determines whether it is advantageous to carry out both shared-channel broadcasting and “regular” broadcasting using a conventional broadcast or control channel. If no advantage in convenience, signaling overhead, etc., is gained by shared-channel broadcasting, the information may be broadcast using conventional broadcast means.

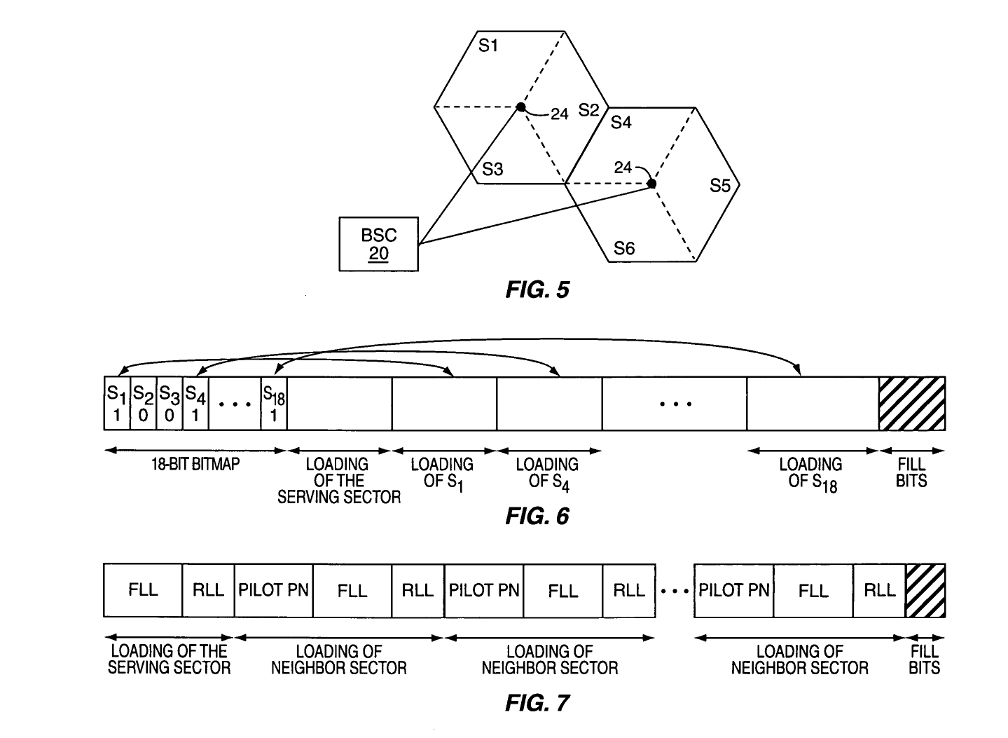

Some types of broadcast information are almost always advantageously broadcast on the shared-channel. Sector loading/congestion information represents one such type of information. Referring to FIG. 5, one sees a partial illustration of the network 10, wherein the multi-sector arrangement of two RBSs 24 is particularly illustrated. According to 1×EV-DV standards, each mobile station 12 receiving service on the shared F-PDCH dynamically chooses a “serving” radio sector, i.e., the mobile station 12 selects the F-PDCH being transmitted in a given RBS radio sector as the F-PDCH that will carry its packet data traffic. The mobile station 12 generally selects a new serving sector as needed, responsive to changing signal conditions. Thus, the mobile station 12 initially may select sector S2 as its F-PDCH serving sector, then select sector S4, and then sector S3, and so on, responsive to changing reception conditions caused by its movement, for example.

Because such autonomous sector selection typically is driven simply by each mobile station 12 evaluating received signal quality for a given set of RBS pilot signals, e.g., the mobile station's “active set” of pilots, a given mobile station 12 may select one radio sector over another, even if the selected sector is more congested. Thus, network 10 may be configured to effect congestion management by providing the mobile stations 12 with sector loading information that the mobile stations 12 can use in making their serving sector selection decisions. Because such decisions rely on the comparison of loading level in a number of radio sectors, and because loading levels may be reported for both forward and reverse links, the amount of loading information needed to allow intelligent sector selection by the mobile stations 12 can be significant. That fact makes the F-PDCH ideal for broadcasting sector-loading information. In other words, it is not problematic to send even large amounts of sector loading information quickly over the F-PDCH because of its high-rate capacity, and its flexibility in allocating transmission slots.

For sending sector loading information in support of congestion control in a 1×EV-DV embodiment, for example, the MAC ID transmitted on the F-PDCCH can be set to “0000010,” and the mobile stations 12 are configured to recognize that ID as connoting the broadcasting of sector loading information on the F-PDCH. The F-PDCH can use small encoder packet sizes, such as 192 bits or 384 bits, so that the transmission power needed to broadcast the sector loading information to all shared-channel mobile stations 12 operating in the given radio sector can be relatively low. Such an arrangement helps to ensure that all such mobile stations 12 receive the sector loading information.

In at least one embodiment, incremental redundancy is not used, and each sector loading broadcast on the F-PDCH in a given radio sector includes all current sector loading information relevant to that sector, e.g., its own sector loading information and loading information for its neighboring sectors. On that point, it should be understood that the RBSs 24 sector loading information can be shared directly between the RBSs 24, or can be reported by each RBS 24 to the BSC 20, which can then distribute the information to the various RBSs 24 under its control, and/or transfer the information to another BSC 20 for distribution to the RBSs 24 operating under the control of that other BSC 20. Even where incremental redundancy is not used, a given broadcast can be repeated for improved reception reliability. For example, with repeated broadcasts on the F-PDCH, the mobile stations 12 can use Chase-combining to improve reception reliability.

As for the formatting of sector loading information broadcasts, FIG. 6 illustrates one method, wherein a cardinal order list of the pilots associated with each F-PDCH active set member is sent to the mobile stations 12 via Layer 3 messaging broadcast over the F-PDCH. That is, Layer 3 messaging can be used to specify the cardinal order of the pilots, and each mobile station 12 can identify its active set members based on their positions in the list. In one embodiment, the broadcast sector-loading message carries 13 bits of information for each listed pilot in order. Of the 13 bits, 8 bits are used to indicate a quantized value of sector loading as measured or estimated for the forward link (Forward Link Loading, or FLL), and 5 bits are used to indicate a quantized value of sector loading as measured or estimated for the reverse link (Reverse Link Loading, or RLL). Further, 9 bits indicate the pseudo noise (PN) number of each pilot in the list.

Because neighboring pilots generally have pilot PNs that are close to each other, certain optimizations may be performed regarding the representation of broadcast sector loading information. For example, differential coding with respect to the Forward/Reverse PDCH serving sectors may allow for the sector loading broadcast to carry loading information for more sectors. If the difference in PN number is above the smaller number of bits used to represent the pilots, then the full 9-bit representation is used. Each pilot representation will occupy an additional bit to indicate whether it is represented in the reduced size, or in the full 9-bit size. A reduced-size pilot representation generally represents a differential coding relative to the last full-size pilot representation in the list, rather than the first or serving sector pilot PN number. However, in one or more embodiments, the reduced-size, differentially encoded pilot representations are referred to the serving sector pilot(s). FIG. 7 illustrates a sector loading broadcast that can comprise full-size pilot representations, or a mix of full-size and differentially encoded pilot representations.

With the above in mind, a 192-bit sector loading broadcast on the F-PDCH can carry FLL and RLL information for up to eight radio sectors, and a 384-bit sector loading broadcast can carry FLL and RLL information for up to sixteen radio sectors. The use of 192-bit transmissions may, under at least some circumstances, offer better or more efficient usage of Walsh coding and forward link transmit power resources. Of course, those skilled in the art will recognize that many different formats and orderings can be used for sending FLL and/or RLL information as broadcast information on the shared channel.

In general, however, increasing the efficiency of sector loading broadcast by reducing the number of bits needed to convey the information benefits the primary purpose of the F-PDCH as a high-rate conduit for delivering packet data traffic individually targeted to respective ones of the mobile stations 12. That is, it is desirable to control the size and frequency of broadcast messages sent over the F-PDCH, to not unduly reduce the effective throughput rate of packet data traffic being carried on it. Of course, such considerations may be modified where the broadcast information comprises BCMCS data being transmitted on an ongoing (scheduled) basis, for example.

Of course, the size and transmission frequency of a given broadcast message sent over the F-PDCH, or sent over another type of shared packet data channel, generally depends on the nature of the information being transmitted. Those skilled in the art will appreciate that the present invention is not limited to a particular message configuration, nor is it limited to a particular type of broadcast information. Indeed, the present invention broadly defines a method and apparatus for transmitting broadcast information over a shared packet data channel based on indicating such broadcasts via signaling on an associated control channel. Therefore, the present invention is not limited by the foregoing disclosure, nor by the accompanying drawings; rather, it is limited only by the following claims and their legal equivalents.

1. A method of sending an in-traffic broadcast to all or a subset of mobile stations sharing a shared packet data channel, the method comprising:
transmitting an in-traffic broadcast message on the shared packet data channel; and
transmitting a corresponding broadcast identifier on an associated packet data control channel to indicate that the corresponding transmission on the shared packet data channel comprises an in-traffic broadcast message rather than packet data traffic individually targeted to a given one of the mobile stations.

2. The method of claim 1, wherein transmitting an in-traffic broadcast message on the shared packet data channel comprises transmitting control information via one or more in-traffic broadcast messages sent on the shared packet data channel.

3. The method of claim 1, wherein transmitting an in-traffic broadcast message on the shared packet data channel comprises at least one of transmitting one or more types of In-Traffic System Parameter messages, transmitting one or more types of Layer 3 signaling messages, transmitting sector loading information messages, transmitting one or more types of Short-Messaging-Service messages, transmitting one or more types of paging messages, and transmitting one or more types of broadcast/multicast service messages.

4. The method of claim 1, wherein the shared packet data channel comprises a Forward Packet Data Channel (F-PDCH) in an IS-2000-based wireless communication network, and wherein the associated packet data control channel comprises a Forward Packet Data Control Channel (F-PDCCH) corresponding to the F-PDCH.

5. The method of claim 1, wherein transmitting an in-traffic broadcast message on the shared packet data channel comprises transmitting sector loading information for one or more radio sectors of a wireless communication network.

6. The method of claim 5, wherein transmitting sector loading information for one or more radio sectors of a wireless communication network comprises sending sector loading information for the radio sector corresponding to the shared packet data channel and the packet data control channel, and for one or more neighboring radio sectors.

7. The method of claim 5, wherein transmitting sector loading information for one or more radio sectors of a wireless communication network comprises sending an ordered list of pilot signal identifiers and corresponding sector loading information for the radio sector corresponding to the shared packet data channel and the packet data control channel, and for one or more neighboring radio sectors.

8. The method of claim 1, wherein transmitting a corresponding broadcast identifier on an associated packet data control channel to indicate that the corresponding transmission on the shared packet data channel comprises an in-traffic broadcast message comprises transmitting one or more designated Medium Access Control (MAC) identifiers.

9. The method of claim 8, further comprising pre-configuring the one or more MAC identifiers used to designate the transmission of in-traffic broadcast messages on the shared packet data.

10. The method of claim 8, further comprising dynamically selecting the one or more MAC identifiers used to designate the transmission of in-traffic broadcast messages on the shared packet data channel, and communicating such selections to the mobile stations sharing the shared packet data channel.

11. A base station system comprising a radio base station configured to transmit a shared packet data channel and an associated packet data control channel, said radio base station comprising one or more processing circuits configured to:
transmit an in-traffic broadcast message on the shared packet data channel; and
transmit a corresponding broadcast identifier on an associated packet data control channel to indicate that the corresponding transmission on the shared packet data channel comprises an in-traffic broadcast message rather than packet data traffic individually targeted to one of the mobile stations sharing the shared packet data channel.

12. The base station system of claim 11, wherein the in-traffic broadcast message conveys control or signaling information for all or a subset of the mobile stations sharing the shared packet data channel.

13. The base station system of claim 11, wherein the in-traffic broadcast message comprises at least one of an In-Traffic System Parameter message, a Layer 3 signaling message, a sector loading information message, a Short-Messaging-Service message, a paging message, or a broadcast/multicast service message.

14. The method of claim 11, wherein the base station system comprises an IS-2000-based radio base station system, and wherein the shared packet data channel comprises a Forward Packet Data Channel (F-PDCH) and the associated packet data control channel comprises a Forward Packet Data Control Channel (F-PDCCH) corresponding to the F-PDCH.

15. The base station system of claim 11, wherein the base station system is configured to broadcast sector loading information for one or more radio sectors by transmitting in-traffic broadcast messages on the shared packet data channel.

16. The base station system of claim 15, wherein the base station system is configured to broadcast sector loading information by sending sector loading information for the radio sector corresponding to the shared packet data channel and the packet data control channel, and for one or more neighboring radio sectors.

17. The base station system of claim 15, wherein the base station system is configured to broadcast sector loading information for one or more radio sectors of a wireless communication network by sending an ordered list of pilot signal identifiers and corresponding sector loading information for the radio sector corresponding to the shared packet data channel and the packet data control channel, and for one or more neighboring radio sectors.

18. The base station system of claim 11, wherein the base station system is configured to transmit one or more designated Medium Access Control (MAC) identifiers on the packet data control channel to indicate that corresponding transmissions on the shared packet data channel comprise in-traffic broadcast messages.

19. The base station system of claim 18, wherein the base station system is configured to store the or more MAC identifiers used to designate the transmission of in-traffic broadcast messages on the shared packet data comprise as statically configured values.

20. The base station system of claim 18, wherein the base station system is configured to maintain the one or more MAC identifiers used to designate the transmission of in-traffic broadcast messages on the shared packet data channel as dynamically configured values, and further is configured to communicate to indicate to the mobile stations which MAC identifiers are being used to indicate the transmission of in-traffic broadcast messages on the shared packet data channel.

21. A method of transmitting broadcast information to a plurality of mobile stations receiving individually targeted packet data traffic over a shared packet data channel, the method comprising identifying which timeslots of the shared packet data channel carry broadcast information instead of individually targeted packet data traffic based on signaling the mobile stations via a packet data control channel that is associated with the shared packet data channel.

22. The method of claim 21, wherein signaling the mobile stations via a packet data control channel that is associated with the shared packet data channel comprises transmitting a designated Medium Access Control (MAC) identifier on one or more timeslots of the packet data control channel to indicate that one or more corresponding timeslots of the shared packet data control channel carry broadcast information rather than individually targeted packet data traffic.

23. The method of claim 21, wherein the broadcast information comprises one or more types of control information.

24. The method of claim 21, wherein the broadcast information comprises a broadcast/multicast data stream.

25. The method of claim 21, wherein the broadcast information comprises Short-Messaging-Services messages.

26. The method of claim 21, wherein the broadcast information comprises paging messages.

27. The method of claim 21, wherein the broadcast information comprises sector loading information transmitted in support of congestion control.
